(19) United States
(12) Patent Application Publication
(10) Pub. No.: US 2010/0289472 A1
(43) Pub. Date: Nov. 18, 2010

(54) LOW DROPOUT VOLTAGE REGULATOR WITH LOW QUIESCENT CURRENT

(75) Inventor: Claude Renous, Grenoble (FR)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMicroelectronics (Grenoble 2) SAS, Grenoble (FR)

(21) Appl. No.: 12/780,569

(22) Filed: May 14, 2010

(30) Foreign Application Priority Data
May 15, 2009 (FR) 0902363

(51) Int. Cl. G05F 1/10

(52) U.S. Cl. 323/282

(57) ABSTRACT

The disclosure relates to a low dropout voltage regulator comprising a regulation transistor to supply an output voltage from an input voltage, a gate control stage to supply a gate voltage to the regulation transistor, and an error amplifier to supply a control voltage to a control terminal of a control transistor. The low dropout voltage regulator also comprises a quiescent current control circuit to limit a quiescent current flowing through the gate control stage when the input voltage approaches the output voltage and causes the regulation transistor to enter into an ohmic conduction mode. The quiescent current control circuit comprises a current source providing a reference current and is configured to control the quiescent current by current-mirror effect based upon the reference current.

### BACKGROUND

1. Technical Field

The present disclosure relates to a low dropout voltage regulator circuit, or LDO. More particularly, the present disclosure relates to a circuit configuration for minimizing quiescent current within an LDO.

2. Description of the Related Art

LDOs are direct current voltage regulators that receive an input voltage from a voltage source, such as a battery, and supply a stable output voltage to an electrical load. The voltage source can vary or be depleted over time, but the load requires a constant supply voltage in order to operate.

The minimum difference between the input and output voltages that still permits the low dropout regulator to regulate the output voltage is known as the “drop out voltage”. This drop out voltage should be as small as possible in order to maximize efficiency while minimizing power dissipation, and thus typically ranges from 0.1 to 1.5 V. As an example, if the drop out voltage is 0.7 V, the input voltage must be at least 4.0 V in order to supply an output voltage of 3.3 V.

Low dropout regulators are particularly useful for portable applications operating on batteries, such as mobile telephones, music players, personal digital assistants, cameras and the like.

A conventional structure of a low dropout regulator LDO1 is shown in FIG. 1. The regulator LDO1 comprises an input node IN and an output node OUT. The input node receives an input voltage Vin supplied by a power source PS, such as a battery. The output node OUT is connected to a load LD and supplies a regulated output voltage Vreg and an output current lout to the load LD.

The regulator LDO1 comprises a regulation transistor TREG, a gate control stage GCS and an error amplifier EAMP.

The regulation transistor TREG, here a PMOS transistor, has its source S connected to the input node IN and its drain D connected to the output node OUT. The gate G of the transistor is driven by a gate voltage Vg supplied by the gate control stage GCS.

The gate control stage GCS comprises a pull-up gate resistor RG1 and a control transistor TQ, here an NPN bipolar transistor. Resistor RG1 has a terminal connected to the input node IN and a terminal connected to the gate G of transistor TREG. Transistor TQ has a collector C connected to the gate G of transistor TREG and an emitter E linked to ground through a resistor RG2.

The base B of transistor TQ receives a control voltage Vc supplied by the error amplifier EAMP. Amplifier EAMP comprises a negative input and a positive input. The negative input receives a stable voltage Vref supplied by a stable voltage source BG, such as a bandgap voltage source. The positive input receives a feedback voltage Vf. The feedback voltage is a percentage of the output voltage Vreg supplied by a voltage divider comprising resistors R1, R2.

The error amplifier compares the reference voltage Vref and the feedback voltage Vf, and supplies the control voltage Vc to the gate control stage GCS.

Quiescent current Iq is defined as the current that is used to bias the gate control stage GCS, and is equal to a current Iin at the input node IN of the regulator minus a current Iout supplied to the load LD and a current lamp supplied to the error amplifier EAMP. The quiescent current is considered to essentially be the current flowing through the gate resistor RG1.

The power efficiency of a low dropout regulator is thus dependent upon the value of currents Iq and Iamp and the input and output voltages, as shown by the following equation:

PowerEff=(Iout*Vreg)/((Iout+Iq+Iamp)*Vin)≦Vreg/Vin

In a normal operating mode in which the input voltage Vin is greater than the output voltage Vreg, the efficiency of an LDO is generally satisfactory. However, the quiescent current Iq greatly increases and the efficiency decreases correspondingly when the input voltage Vin approaches the output voltage Vreg. This is because the regulation transistor TREG enters into its ohmic conduction mode and the gate voltage Vg goes towards zero, greatly increasing the quiescent current Iq. This poses a problem when the voltage regulator is powered by a battery, since the more the battery discharges, the more the quiescent current Iq is high and causes the battery to discharge even faster.

For the sake of illustration, FIGS. 2A and 2B show characteristic curves C1, C2 of voltages Vin, Vreg, corresponding curves C3, C4 of gate voltage Vg for two different values of Iout, respectively 50 nA and 50 mA, and curves C5, C6 of the quiescent current Iq for Iout=50 nA and Iout=50 mA, respectively. The reference voltage Vref is taken to be 1.8 V, and R2 is taken to be equal to 0. The horizontal axis represents time and it is assumed that the voltage Vin is progressively decreasing as the power source discharges.

A vertical dashed line shows the limit where Vin−Vreg=0.2 V (where 0.2 V is the threshold voltage of the regulation transistor TREG) and the side to the right of the dashed line represents an operating region of the regulation transistor where Vin−Vreg<0.2 V, corresponding to an ohmic conduction mode. It can be seen that the quiescent current Iq is substantially constant in the region situated on the side to the left of the dashed line and begins to increase when the omhic region is reached, in particular when the current consumption of the load is high. For both current consumptions (50 nA and 50 mA) the quiescent current abruptly increases and reaches a maximum value when the output voltage Vreg is almost equal to the input voltage Vin (Vin−Vreg<0.2 V). In fact, the error amplifier EAMP tries to maintain the output voltage at its nominal value (Vref) and pulls down the gate voltage Vg. Assuming that the V_{CE} voltage across transistor TQ is very low, the maximum value of the quiescent current is approximately equal to Vin/(RG1+RG2).

It can be noted that the current lamp through the error amplifier is generally constant so it will be considered that nothing can be done to control its value.

Therefore, it may be desired to provide a low dropout regulator in which the quiescent current Iq does not greatly increase when the regulation transistor is in the ohmic conduction mode.

U.S. Pat. No. 7,312,598 discloses a low dropout regulator with a quiescent current control circuit comprising a PMOS sensing transistor able to detect a low load current, such as 0.5 mA. In a low load current state, a voltage Vqc is set to a logically high value. The regulator, upon sensing the low load current state, generates a relatively low quiescent current by disabling some components, and thereby less power is consumed.

When a high load current state is sensed, voltage Vqc is set logically low so that any components disabled for the low load state are quickly enabled for full operation.

### BRIEF SUMMARY

Embodiments of the invention provide a low dropout voltage regulator comprising a regulation transistor to supply a regulated output voltage from an input voltage; a gate control stage comprising a pull-up gate resistor circuit and a control transistor, to supply a gate voltage to the regulation transistor; an error amplifier to supply a control voltage to a control terminal of the control transistor; and a quiescent current control circuit to limit a quiescent current flowing through the gate control stage when the input voltage approaches the output voltage and causes the regulation transistor to enter into an ohmic conduction mode. The quiescent current control circuit comprises a current source providing a reference current and is configured to control the quiescent current by current-mirror effect based upon the reference current.

According to one embodiment of the invention, the current control circuit is also configured to simultaneously control the control voltage supplied by the error amplifier to the control terminal of the control transistor.

According to one embodiment of the invention, the current control circuit comprises an output which is linked to the control terminal of the control transistor and is configured to modify the control voltage supplied by the error amplifier to the control terminal.

According to one embodiment of the invention, the quiescent current control circuit comprises a first transistor having a first conduction terminal linked to the current source, a second conduction terminal arranged to receive the output voltage and a control terminal arranged to receive the gate voltage, and the gate resistor circuit comprises a transistor that is coupled in current-mirror configuration with the first transistor of the quiescent current control circuit.

According to one embodiment of the invention, the low dropout voltage regulator comprises a Miller compensation branch connected between a conduction terminal of the control transistor and the first conduction terminal of the control transistor.

According to one embodiment of the invention, the quiescent current control circuit comprises a second transistor having a control terminal linked to the first conduction terminal of the first transistor, a first conduction terminal linked to ground, and a second conduction terminal linked to the control terminal of the control transistor.

According to one embodiment of the invention, the gate resistor circuit comprises a gate transistor interacting with a transistor of the quiescent current control circuit so as to create a current-mirror between the quiescent current control circuit and the gate control stage.

According to one embodiment of the invention, the gate resistor circuit also comprises a first resistor in parallel with the gate transistor and a second resistor in series with the first resistor.

According to one embodiment of the invention, the quiescent current control circuit is configured to be in an off state in which it does not does not consume any current when the regulation transistor has not entered into the ohmic conduction mode.

According to one embodiment of the invention, the regulation transistor is in the ohmic conduction mode when the voltage difference between the input voltage and the regulated output voltage is less than or equal to 0.2 V.

Embodiments of the invention also relate to a handheld device comprising a battery to supply an input voltage, a circuit powered by a regulated voltage, and a low dropout voltage regulator according to one of the above embodiments, to supply the regulated output voltage from the input voltage.

### BRIEF DESCRIPTION OF THE SEVERAL VIEWS OF THE DRAWINGS

An embodiment of a low dropout voltage regulator will be described in the following description, in connection with, but not limited to, the appended drawings in which:

FIG. 1, previously described, shows a conventional structure of a low dropout regulator;

FIGS. 2A and 2B, previously described, show voltage and current characteristics of the regulator of FIG. 1;

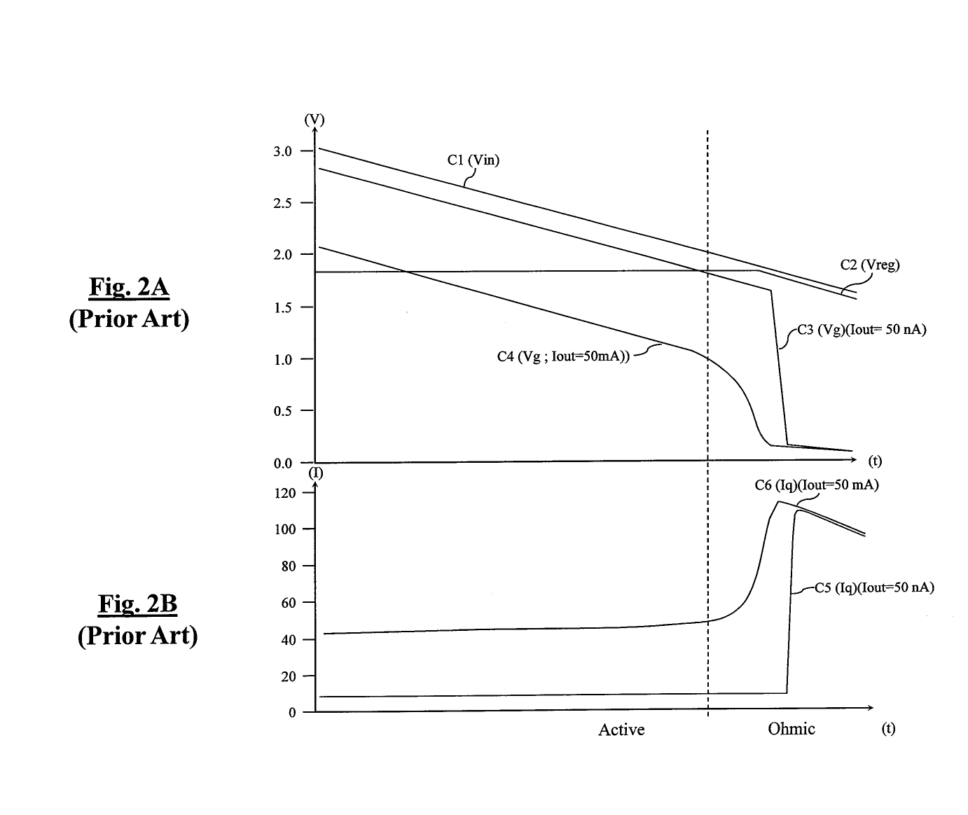

FIG. 3 shows a low dropout regulator according to an embodiment of the invention;

FIG. 4 shows an example of implementation of the regulator of FIG. 3;

FIGS. 5A and 5B show voltage and current characteristics of the low dropout regulator according to an embodiment of the invention; and

FIG. 6 schematically shows a handheld device comprising a low dropout regulator according to an embodiment of the invention.

### DETAILED DESCRIPTION

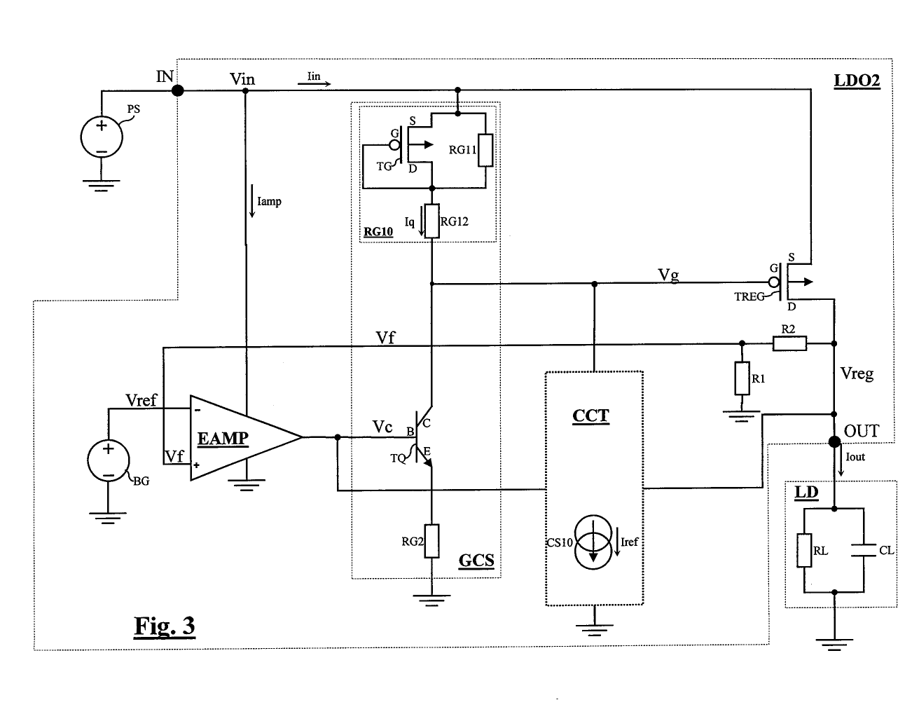

FIG. 3 shows a low dropout regulator LDO2 in accordance with an embodiment of the invention. The regulator LDO2 comprises an input node IN and an output node OUT. The input node receives an input voltage Vin supplied by a power source PS, such as a battery. The output node OUT is connected to a load LD schematically represented by a resistor RL and a capacitor CL in parallel, and supplies a regulated output voltage Vreg and an output current lout to the load LD.

The regulator LDO2 comprises a regulation transistor TREG, a gate control stage GCS, an error amplifier EAMP (differential amplifier) and a quiescent current control circuit CCT.

The regulation transistor TREG, here a PMOS transistor, has its source S connected to node IN and its drain D connected to the node OUT. The gate G of the transistor is driven by a gate voltage Vg supplied by the gate control stage GCS.

The gate control stage GCS comprises a pull-up gate resistor circuit RG10 and a control transistor TQ, here an NPN bipolar transistor. Gate resistor circuit RG10 has a terminal connected to the input node IN and a terminal connected to the gate G of transistor TREG. Transistor TQ has a collector C connected to the gate G of transistor TREG and an emitter E linked to ground (GND) through a resistor RG2.

The base B of transistor TQ receives a control voltage Vc supplied by the error amplifier EAMP. Amplifier EAMP comprises a negative input and a positive input. The negative input receives a stable voltage Vref supplied by a stable voltage source BG such as a bandgap voltage source. The positive input receives a feedback voltage Vf. The feedback voltage is a percentage of the output voltage Vreg supplied by a voltage divider comprising resistors R1, R2.

The error amplifier compares the reference voltage Vref and the feedback voltage Vf, and supplies the control voltage Vc to the gate control stage GCS.

The quiescent current control circuit CCT has two inputs connected respectively to the gate G of transistor TREG and to the output node OUT of the regulator, and an output connected to the base B of transistor TQ. The quiescent current control circuit CCT has an internal current source CS10, and is arranged to sense the gate voltage Vg applied by the gate control stage GCS to the transistor TREG. When the gate voltage Vg reaches a value which indicates that the transistor TREG has entered into the ohmic conduction mode, the quiescent current control circuit CCT activates and controls the quiescent current Iq flowing through the gate control stage GCS in order to prevent the quiescent current from reaching excessive values. The quiescent current control circuit CCT also “takes over” from the error amplifier EAMP and takes control of the voltage Vc applied to the base B of transistor TQ in order to control the gate voltage Vg of the regulation transistor TREG.

The control of the quiescent current Iq by control circuit CCT is performed by means of a current-mirror mechanism between the current source CS 10 and the gate control stage GCS.

In order to implement such a current mirror mechanism, a transistor may be added in the gate control stage GCS. For example, a PMOS transistor TG is arranged in the gate resistor circuit RG10, i.e., in the pull-up section of the gate control stage GCS, which receives the input voltage Vin and supplies the gate voltage Vg. In an embodiment, the gate resistor circuit RG10 comprises two resistors RG11, RG12 in series, and transistor TG is diode-mounted in parallel with resistor RG11, its drain D being connected to its gate G. Resistor RG11 has a high value, for example 1 MΩ, and is provided as a leakage resistor to make sure that the gate voltage Vg of the regulation transistor TREG receives the input voltage Vin in the absence of control by the error amplifier, for example when the circuit powers on. On the other hand, resistor RG12 has a low value, for example 10 KΩ.

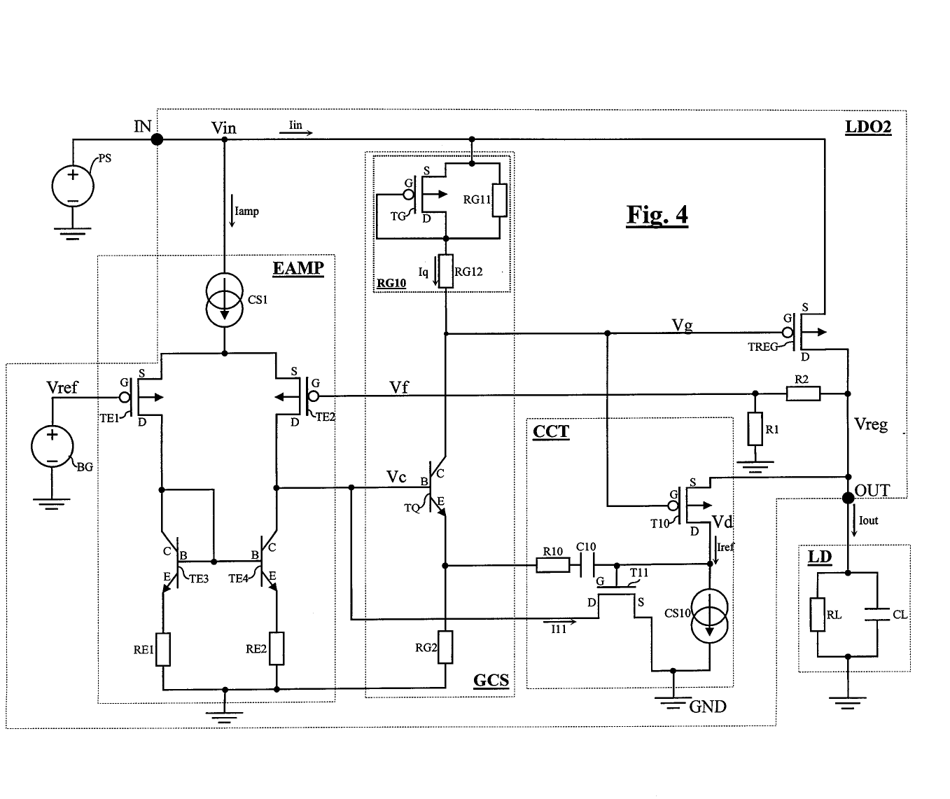

FIG. 4 shows an example of implementation of quiescent current control circuit CCT and an example of implementation of the error amplifier EAMP.

The quiescent current control circuit CCT comprises a PMOS transistor T10, an NMOS transistor T11, and the current source CS10. In one embodiment, a Miller compensation branch comprising for example a resistor R10 and a capacitor C10 may also be provided.

Transistor T10 has its source S connected to output node OUT of the regulator LDO2, its drain D linked to ground (GND) through the current source CS10, and its gate G connected to the gate G of the regulation transistor TREG in order to sense the gate voltage Vg. Transistor T11 has its gate connected to the drain D of transistor T10, its drain D linked to the base B of transistor TQ, and its source S linked to ground. The Miller compensation branch, comprising resistor R10 and capacitor C10, is connected between the emitter E of transistor TQ and the drain D of transistor T10.

The error amplifier EAMP conventionally comprises a current source CS1, PMOS transistors TE1, TE2, NPN bipolar transistors TE3, TE4 and resistors RE1, RE2. The current source CS1 has a first terminal connected to the input node IN of the regulator, and a second terminal connected to the sources S of transistors TE1, TE2. The drains D of transistors TE1, TE2 are respectively connected to the collectors C of transistors TE3, TE4. The emitters E of transistors TE3, TE4 are respectively linked to ground through resistors RE1, RE2. The collector C of transistor TE4 is connected to the base B of transistor TQ and supplies the control voltage Vc when the quiescent current control circuit CCT is in the off state. The bases B of transistors TE3, TE4 are both connected to the collector C of transistor TE3. Finally, the gate G of transistor TE1 receives the reference voltage Vref and the gate G of transistor TE2 receives the feedback voltage Vf.

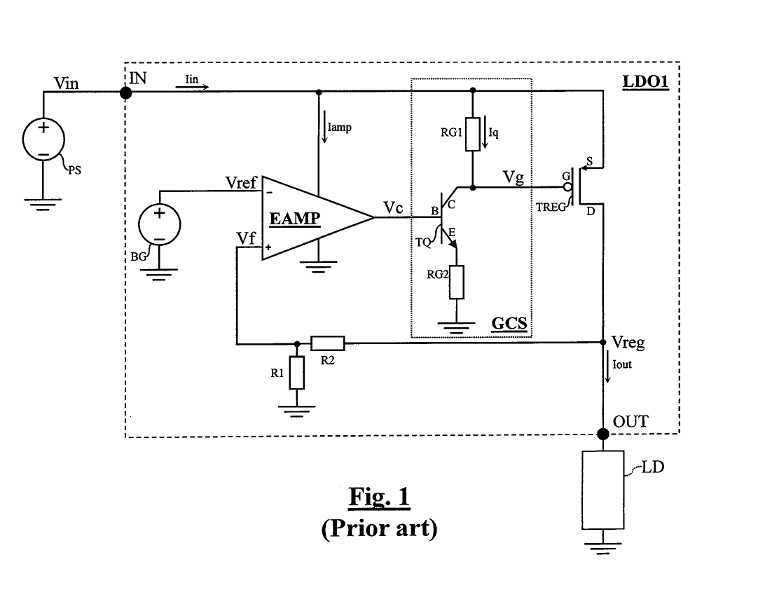

The quiescent current control circuit CCT is arranged to monitor the voltage difference between the gate voltage Vg and the output voltage Vreg. When the difference between the input voltage Vin and the output voltage Vreg is large, for example when the power source PS is a fully charged battery, transistor T10 of the quiescent current control circuit CCT is in the off state (non-conducting) because the voltage difference Vgs between its gate G and source S is positive and therefore greater than its negative threshold voltage (Vg>Vreg). The current source CS10 also prevents transistor T11 from conducting. Therefore, the quiescent current control circuit CCT is in the off state and does not interfere with the normal operation of the error amplifier EAMP. Furthermore, it does not consume any current. The regulator LDO2 functions like the conventional regulator LDO1 of FIG. 1.

When the input voltage Vin decreases, for example as the power source PS discharges if it is a battery, the error amplifier EAMP tries to maintain the desired output voltage Vreg, as previously explained. The gate voltage Vg begins to decrease and the difference between the gate voltage and source voltage of transistor T10, which is equal to Vg−Vreg, becomes negative and inferior to its negative threshold voltage (Vg<Vreg). Transistor TQ strongly conducts and transistor T10 starts to conduct. Current source CS10 imposes a current Iref through transistor T10 and also limits the quiescent current by current-mirror effect.

The ratio between the controlled quiescent current Iq and current Iref is determined by the respective dimensions of transistors T10 and TG, that is to say their respective W/L ratios (W being the gate width and L being the gate length of the transistors). Therefore, the quiescent current typically does not exceed a value fixed by the current mirror. Resistor R10 and capacitor C10 help to stabilize the current mirror.

Simultaneously, the drain voltage of transistor T10 causes the transistor T11 to start conducting, thereby controlling the base voltage Vb of transistor TQ and preventing the error amplifier EAMP from pulling up the control voltage Vc. The base B of transistor TQ is brought towards ground, and transistor T11 regulates the conduction of transistor TQ. Transistor T11 controls the base B of transistor TQ so as to make sure that Iref is equal to the current through the current source CS10, so that a further regulation mechanism occurs. When Iref is equal to the current through CS10, the current Iq is controlled and is equal to Iref or proportional to Iref depending upon the W/L ratios.

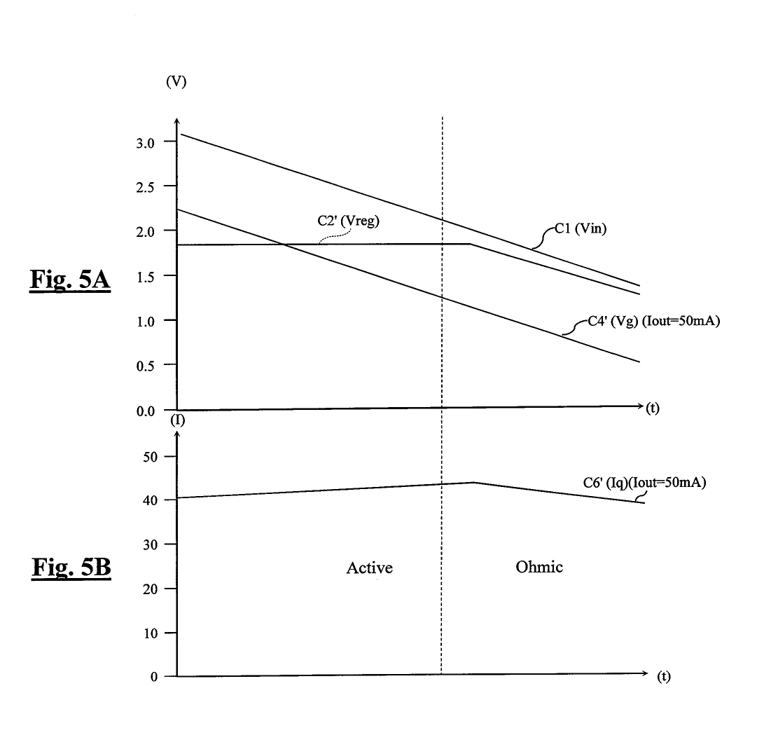

For the sake of illustration, FIGS. 5A and 5B show characteristic curves C1, C2′ of voltages Vin, Vreg and corresponding curves C4′ of gate voltage Vg and C6′ of the quiescent current Iq for Iout=50 mA. The reference voltage Vref is taken to be 1.8 V, and R2 is taken to be equal to 0. The horizontal axis represents time and it is assumed that the voltage Vin is progressively decreasing.

A vertical dashed line shows the limit where Vin−Vreg=0.2 V and the side to the right of the dashed line represents an operating region of the regulation transistor where Vin−Vreg<0.2 V (ohmic conduction mode). As in the conventional regulator LDO1, the quiescent current Iq is substantially constant in the region situated to the left of the dashed line. When the ohmic conduction mode is reached, Vin approaches the nominal value of the output voltage Vreg and Vin−Vreg becomes equal to 0.2 V. It can be seen that the quiescent current control circuit CCT prevents the gate control stage GCS from rapidly pulling down the gate voltage Vg while preventing the quiescent current Iq from abruptly increasing. The quiescent current Iq is maintained at approximately the same value it had before the ohmic conduction mode was reached.

From the foregoing it will be appreciated that, although specific embodiments of the invention have been described herein for purposes of illustration, various modifications may be made without deviating from the spirit and scope of the embodiments disclosed as defined by the appended claims. In particular, it is within the knowledge of the skilled person to add components to the described embodiments, to delete or replace some components, to use another type of reference voltage source than a bandgap reference, to use a different type of regulation transistor, to substitute some bipolar transistors for some MOS transistors or reciprocally, to substitute NPN bipolar transistors for PNP bipolar transistors or reciprocally, to substitute NMOS transistors for PMOS transistors or reciprocally, etc.

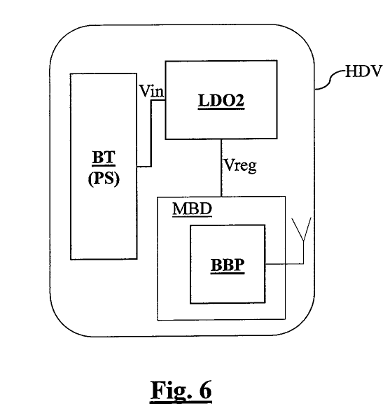

FIG. 6 schematically shows an example application of a low dropout regulator LDO2 according to one embodiment of the invention. The low dropout regulator LDO2 is arranged in a handheld device HDV having a battery BT forming its power source PS, and circuitry upon a motherboard MBD. The circuitry may comprise, for example, a baseband processor BBP configured to establish a telephone communication through a cellular network. The battery supplies the input voltage Vin of the regulator LDO2 and the regulated voltage Vreg supplied by the regulator LDO2 powers some or all of the components of the motherboard, in particular the baseband processor BBP.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A low dropout voltage regulator comprising:
a regulation transistor configured to supply a regulated output voltage from an input voltage;
a gate control stage configured to supply a gate voltage to the regulation transistor, the gate control stage including a pull-up gate resistor circuit and a control transistor;
an error amplifier configured to supply a control voltage to a control terminal of the control transistor; and
a quiescent current control circuit configured to limit a quiescent current flowing through the gate control stage when the input voltage approaches the output voltage and causes the regulation transistor to enter into an ohmic conduction mode, the quiescent current control circuit including a current source configured to provide a reference current, the quiescent current control circuit being configured to control the quiescent current by current-mirror effect based upon the reference current.

2. A low dropout voltage regulator according to claim 1, wherein the current control circuit is also configured to control the control voltage simultaneously with limiting the quiescent current.

3. A low dropout voltage regulator according to claim 2, wherein the current control circuit comprises an output coupled to the control terminal of the control transistor and is configured to modify the control voltage supplied by the error amplifier to the control terminal.

4. A low dropout voltage regulator according to claim 1, wherein:
the quiescent current control circuit comprises a first transistor having a first conduction terminal coupled to the current source, a second conduction terminal arranged to receive the output voltage and a control terminal arranged to receive the gate voltage, and
the gate resistor circuit comprises a second transistor that is coupled in current-mirror configuration with the first transistor of the quiescent current control circuit.

5. A low dropout voltage regulator according to claim 4, comprising a Miller compensation branch coupled between a conduction terminal of the control transistor and the first conduction terminal of the first transistor.

6. A low dropout voltage regulator according to claim 4, wherein the quiescent current control circuit comprises a third transistor having a control terminal coupled to the first conduction terminal of the first transistor, a first conduction terminal coupled to ground, and a second conduction terminal coupled to the control terminal of the control transistor.

7. A low dropout voltage regulator according to claim 1, in which the gate resistor circuit comprises a gate transistor and the quiescent current control circuit includes a transistor that forms, with the gate transistor, a current-mirror between the quiescent current control circuit and the gate control stage.

8. A low dropout voltage regulator according to claim 7, in which the gate resistor circuit also comprises a first resistor in parallel with the gate transistor, and a second resistor in series with the first resistor and the gate transistor.

9. A low dropout voltage regulator according to claim 1, in which the quiescent current control circuit is configured to be in an off state in which the quiescent current control circuit does not consume any current when the regulation transistor has not entered into the ohmic conduction mode.

10. A low dropout voltage regulator according to claim 1, in which the regulation transistor is in the ohmic conduction mode when a voltage difference between the input voltage and the regulated output voltage is less than or equal to 0.2 V.

11. A handheld device comprising:
a battery configured to supply an input voltage;
a circuit powered by a regulated voltage; and
a low dropout voltage regulator configured to supply the regulated output voltage from the input voltage, the low dropout voltage regulator including:
a regulation transistor configured to supply a regulated output voltage from an input voltage;
a gate control stage configured to supply a gate voltage to the regulation transistor, the gate control stage including a pull-up gate resistor circuit and a control transistor;
an error amplifier configured to supply a control voltage to a control terminal of the control transistor; and
a quiescent current control circuit configured to limit a quiescent current flowing through the gate control stage when the input voltage approaches the output voltage and causes the regulation transistor to enter into an ohmic conduction mode, the quiescent current control circuit including a current source configured to provide a reference current, the quiescent current control circuit being configured to control the quiescent current by current-mirror effect based upon the reference current.

12. A handheld device according to claim 11, wherein the current control circuit is also configured to control the control voltage simultaneously with limiting the quiescent current.

13. A handheld device according to claim 12, wherein the current control circuit comprises an output coupled to the control terminal of the control transistor and is configured to modify the control voltage supplied by the error amplifier to the control terminal.

14. A handheld device according to claim 11, wherein:
the quiescent current control circuit comprises a first transistor having a first conduction terminal coupled to the current source, a second conduction terminal arranged to receive the output voltage and a control terminal arranged to receive the gate voltage, and
the gate resistor circuit comprises a second transistor that is coupled in current-mirror configuration with the first transistor of the quiescent current control circuit.

15. A handheld device according to claim 14, comprising a Miller compensation branch coupled between a conduction terminal of the control transistor and the first conduction terminal of the first transistor.

16. A handheld device according to claim 14, wherein the quiescent current control circuit comprises a third transistor having a control terminal coupled to the first conduction terminal of the first transistor, a first conduction terminal coupled to ground, and a second conduction terminal coupled to the control terminal of the control transistor.

17. A handheld device according to claim 14, in which the gate resistor circuit comprises a gate transistor and the quiescent current control circuit includes a transistor that forms, with the gate transistor, a current-mirror between the quiescent current control circuit and the gate control stage.

18. A handheld device according to claim 17, in which the gate resistor circuit also comprises a first resistor in parallel with the gate transistor, and a second resistor in series with the first resistor and the gate transistor.

19. A low dropout voltage regulator comprising:
a regulation transistor having a gate, a first conduction terminal coupled to an input voltage terminal, and a second conduction terminal coupled to a regulated voltage terminal;
a gate control stage configured to supply a gate voltage to the gate of the regulation transistor, the gate control stage including a pull-up gate resistor circuit and a control transistor;
an error amplifier configured to supply a control voltage to a control terminal of the control transistor; and
a quiescent current control circuit configured to limit a quiescent current flowing through the gate control stage when the regulation transistor is in an ohmic conduction mode, the quiescent current control circuit including:
a current source configured to provide a reference current, and
a first transistor having a first conduction terminal coupled to the current source, a second conduction terminal coupled to the regulated voltage terminal, and a control terminal coupled to the gate of the regulation transistor, the first transistor and regulation transistor being a first mirror leg of a current mirror that includes the gate control stage as a second mirror leg.

20. A low dropout voltage regulator according to claim 19, wherein the current control circuit is also configured to control the control voltage simultaneously with limiting the quiescent current.

21. A low dropout voltage regulator according to claim 20, wherein the current control circuit comprises an output coupled to the control terminal of the control transistor and is configured to modify the control voltage supplied by the error amplifier to the control terminal.

22. A low dropout voltage regulator according to claim 19, wherein the pull-up resistor circuit comprises a second transistor that is coupled in current-mirror configuration with the first transistor of the quiescent current control circuit.

23. A low dropout voltage regulator according to claim 22, in which the pull-up resistor circuit also comprises a first resistor in parallel with the second transistor, and a second resistor in series with the first resistor and the second transistor.

24. A low dropout voltage regulator according to claim 19, comprising a Miller compensation branch coupled between a conduction terminal of the control transistor and the first conduction terminal of the first transistor.

25. A low dropout voltage regulator according to claim 19, wherein the quiescent current control circuit comprises a second transistor having a control terminal coupled to the first conduction terminal of the first transistor, a first conduction terminal coupled to ground, and a second conduction terminal coupled to the control terminal of the control transistor.
